(19) United States
(12) Patent Application Publication
(10) Pub. No.: US 2011/0299159 A1
(43) Pub. Date: Dec. 8, 2011

(54) SHUTTER EYEGLASSES

(75) Inventor: Hiroshi Ohno, Tokyo (JP)

(73) Assignee: SONY CORPORATION, Tokyo (JP)

(21) Appl. No.: 13/116,609

(22) Filed: May 26, 2011

(30) Foreign Application Priority Data
Jun. 4, 2010 (JP) P2010-129423

(51) Int. Cl. G02B 27/22

(52) U.S. Cl. 359/462

(57) ABSTRACT

Shutter eyeglasses include: shutter lenses; an eyeglass frame which supports the shutter lenses; a light sensing section attached to the eyeglass frame; and a control section which controls driving of the shutter lenses on the basis of an infrared signal received by the light sensing section, wherein the light sensing section includes an infrared light receiving sensor, an infrared filter, and a condensing lens which concentrates light that has penetrated the infrared filter, toward the light sensing section and in which the larger the radial position becomes, the longer the focal length becomes.

### BACKGROUND OF THE INVENTION

The present disclosure relates to shutter eyeglasses that a viewer wear to view a stereoscopic picture in which left and right pictures are displayed in a time-division manner, and, particularly, to shutter eyeglasses that receive a notification of a shutter opening and closing timing or the like using infrared communication.

A stereoscopic picture that is seen in three-dimension by a viewer can be presented by displaying pictures having parallax with respect to the left and right eyes. As one method of presenting a stereoscopic picture, a method in which a viewer wears eyeglasses having special optical characteristics and images imparted with parallax are presented to both eyes can be exemplified. For example, a time-division stereoscopic picture display system includes a combination of a display device that displays a plurality of different pictures in a time-division manner and shutter eyeglasses that a picture viewer puts on.

The display device alternately displays on a screen a picture for the left eye and a picture for the right eye for a very short period and at the same time, separately provides the pictures to the left eye and the right eye in synchronization with the periods of the picture for the left eye and the picture for the right eye. On the other hand, the shutter eyeglasses mounted on a viewer have a shutter mechanism which is constituted by a liquid crystal cell or the like, at each of a left eye portion and a right eye portion. In the shutter eyeglasses, during display of the picture for the left eye, the left eye portion of the shutter eyeglasses transmits light and the right eye portion shields light. Also, during display of the picture for the right eye, the right eye portion of the shutter eyeglasses transmits light and the left eye portion shields light (refer to Japanese Unexamined Patent Application Publication No. 9-138384, Japanese Unexamined Patent Application Publication No. 2000-36969, and Japanese Unexamined Patent Application Publication No. 2003-45343, for example). That is, a stereoscopic picture is presented to a viewer by performing time-division display of the picture for the right eye and the picture for the left eye by the display device and making the shutter eyeglasses perform image selection by the shutter mechanisms in synchronization with display switching of the display device.

In the time-division stereoscopic picture display system, generally, the display device generates a reference pulse in synchronization with switching between the left eye picture and the right eye picture and notifies the shutter eyeglasses of the opening and closing timings of a shutter based on the reference pulse. Then, on the shutter eyeglasses side, opening and closing operations of the left and right shutters are alternately performed on the basis of the notified shutter opening and closing timing.

In many cases, infrared communication is used in communication between the display device and the shutter eyeglasses. In order to send an infrared signal to the shutter eyeglasses of a viewer relatively far away from the display device, it is preferable if the output of a transmitter on the display device side is increased. However, since the infrared communication has already been widely applied to a remote control operation or the like, a high-power infrared signal may interfere with a neighboring remote control device. Also, there is also a problem that power consumption increases due to a high output.

Usually, an infrared receiving section of the shutter eyeglasses is attached such that a light receiving surface thereof faces the front. Also, at the display device side, an infrared transmitter is disposed around a screen. When a viewer is viewing a stereoscopic picture, the shutter eyeglasses face the approximate center of the screen of the display device. For this reason, when the viewing distance from the display device to the shutter eyeglasses is short, the incident angle at which the infrared signal that is sent from the transmitter on the display device side enters a light sensing section on the shutter eyeglasses side becomes large. Accordingly, since the intensity of the infrared light that is received by the light sensing section is large, it is not necessary for a condensing lens to be provided (refer to FIG. 9).

On the other hand, when the viewing distance is long, since the incident angle at which the infrared signal enters into the light sensing section on the shutter eyeglasses side is small and the intensity of the infrared light that is received by the light sensing section also becomes small, it is necessary for the condensing lens to be provided (refer to FIG. 10). However, if the condensing lens is used even at a close viewing distance, since the incident angle becomes large, there is a problem in that the infrared light easily deviates from the light sensing section, so that the intensity of the received infrared light is reduced.

### SUMMARY OF THE INVENTION

It is desirable to provide excellent shutter eyeglasses which can efficiently receive an infrared signal that carries a notification of shutter opening and closing timings or the like.

According to an embodiment of the present disclosure, there is provided shutter eyeglasses including: shutter lenses; an eyeglass frame which supports the shutter lenses; a light sensing section attached to the eyeglass frame; and a control section which controls driving of the shutter lenses on the basis of an infrared signal received by the light sensing section, wherein the light sensing section includes an infrared light receiving sensor, an infrared filter, and a condensing lens which concentrates light that has penetrated the infrared filter, toward the light sensing section and in which the larger the radial position becomes, the longer the focal length becomes.

In the configuration of the embodiment of the present disclosure, the light receiving sensor of the shutter eyeglasses may be buried in a hole portion formed in the eyeglass frame and the condensing lens may be supported at the opening portion of the hole portion.

In the configuration of the embodiment of the present disclosure, the light receiving sensor of the shutter eyeglasses may be buried in a hole portion formed in the eyeglass frame and the condensing lens may be supported by the infrared filter attached to the opening portion of the hole portion.

According to the embodiment of the present disclosure, it is possible to provide excellent shutter eyeglasses which can efficiently receive an infrared signal that carries a notification of a shutter opening and closing timing or the like.

Other purposes, features, and advantages of the present disclosure will become apparent from the more detailed description based on embodiments of the present disclosure, which will be described later, or the accompanying drawings.

### BRIEF DESCRIPTION OF THE DRAWINGS

FIG. 1A is a diagram schematically illustrating a configuration example of a time-division stereoscopic picture display system.

FIG. 1B is a diagram schematically illustrating a configuration example of the time-division stereoscopic picture display system.

FIG. 1C is a diagram schematically illustrating a functional configuration of shutter eyeglasses.

FIG. 2 is a diagram illustrating an appearance configuration of shutter eyeglasses related to an embodiment of the present disclosure.

FIG. 3 is a diagram illustrating a state where a light sensing section is incorporated in a bridge portion of the shutter eyeglasses.

FIG. 4 is a diagram illustrating a cross-sectional configuration in the vicinity of the light sensing section of the shutter eyeglasses.

FIG. 5A is a diagram for illustrating an action (however, when an incident angle is small) in which a condensing lens (however, in a case where a focal length is constant) concentrates incident light.

FIG. 5B is a diagram for illustrating an action (however, when an incident angle is large) in which the condensing lens (however, in a case where a focal length is constant) concentrates incident light.

FIG. 5C is a diagram for illustrating an action (however, when an incident angle is large) in which the condensing lens (however, in a case where a focal length is constant) concentrates incident light.

FIG. 6A is a diagram for illustrating an action (however, when an incident angle is small) in which the condensing lens (however, in a case where a focal length becomes longer as the radial position becomes larger) concentrates incident light.

FIG. 6B is a diagram for illustrating an action (however, when an incident angle is large) in which the condensing lens (however, in a case where a focal length becomes longer as a radial position becomes larger) concentrates incident light.

FIG. 6C is a diagram for illustrating an action (however, when an incident angle is large) in which the condensing lens (however, in a case where a focal length becomes longer as a radial position becomes larger) concentrates incident light.

FIG. 7 is a diagram illustrating a specific configuration example of the condensing lens.

FIG. 8A is a diagram illustrating a cross-sectional configuration (modified example) in the vicinity of the light sensing section of the shutter eyeglasses.

FIG. 8B is a diagram for illustrating an action (however, when an incident angle is small) in which the condensing lens (however, in a case where a focal length becomes longer as a radial position becomes larger) supported on an infrared filter concentrates incident light.

FIG. 8C is a diagram for illustrating an action (however, when an incident angle is large) in which the condensing lens (however, in a case where a focal length becomes longer as a radial position becomes larger) supported on the infrared filter concentrates incident light.

FIG. 8D is a diagram for illustrating an action (however, when an incident angle is large) in which the condensing lens (however, in a case where a focal length becomes longer as a radial position becomes larger) supported on the infrared filter concentrates incident light.

FIG. 9 is a diagram illustrating a state where a display device (TV) and the shutter eyeglasses perform infrared communication at a short viewing distance.

FIG. 10 is a diagram illustrating a state where the display device (TV) and the shutter eyeglasses perform infrared communication at a long viewing distance.

### DETAILED DESCRIPTION OF EMBODIMENTS

Hereinafter, embodiments of the present disclosure will be described in detail with reference to the drawings.

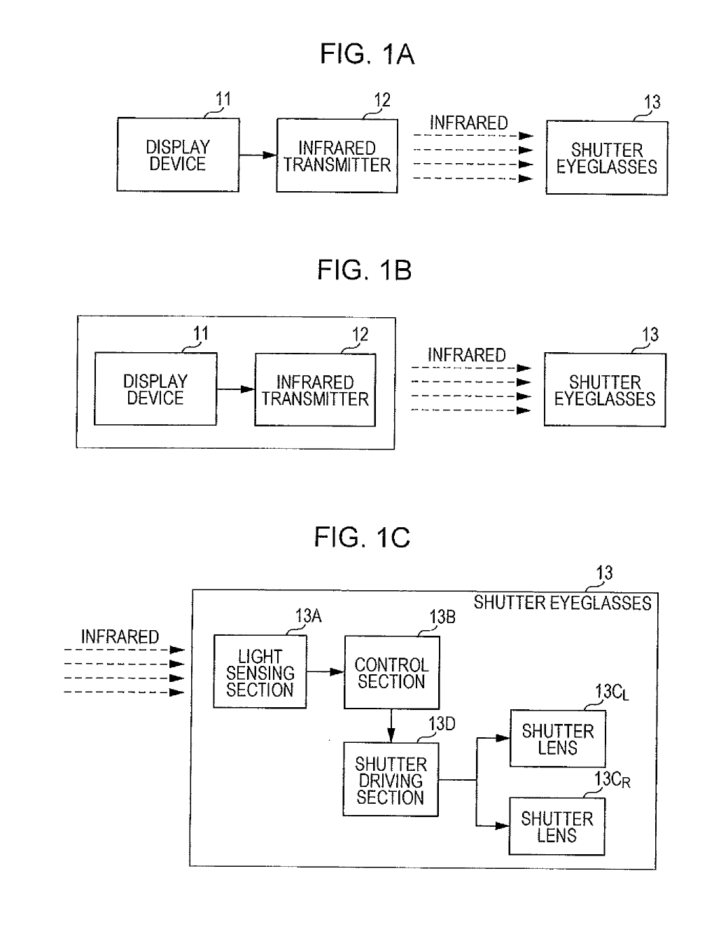

In FIGS. 1A to 1C, a configuration example of a time-division stereoscopic picture display system is schematically illustrated. In an example illustrated in FIG. 1A, an infrared signal is transmitted from an infrared transmitter 12 connected to a display device 11 through an external terminal to shutter eyeglasses 13. Also, in an example illustrated in FIG. 1B, an infrared signal is transmitted from the infrared transmitter 12 built into the main body of the display device 11 to the shutter eyeglasses 13.

In FIG. 1C, a functional configuration of the shutter eyeglasses 13 is schematically illustrated. The shutter eyeglasses 13 include a light sensing section 13A which receives an infrared signal from the display device 11, a control section 13B, shutter lenses 13C_{L} and 13C_{R} for the left eye and the right eye, and a shutter driving section 13D. The display device 11 generates a reference pulse in synchronization with switching of a picture for the left eye and a picture for the right eye and notifies the shutter eyeglasses 13 of the opening and closing timings of a shutter based on the reference pulse using the infrared signal. If the control section 13B obtains information about the opening and closing timing of the shutter on the basis of the infrared signal received by the light sensing section 13A, the control section 13B instructs the shutter driving section 13D to perform opening and closing operations of the shutter lenses 13C_{L} and 13C_{R}. During display of the picture for the left eye, the shutter lens 13C_{L} transmits light and the shutter lens 13C_{R} shields light. Also, during display of the picture for the right eye, the shutter lens 13C_{R} transmits light and the shutter lens 13C_{L} shields light.

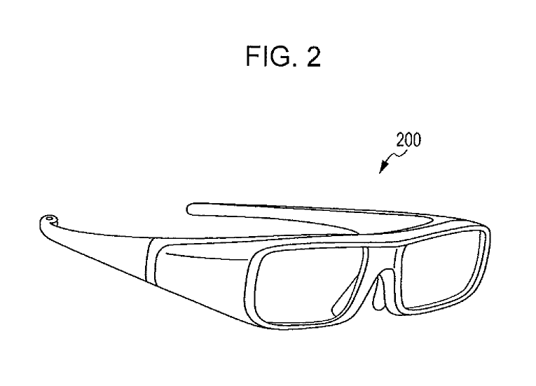

In FIG. 2, an appearance configuration of the shutter eyeglasses related to an embodiment of the present disclosure is illustrated. The illustrated configuration of an eyeglass frame is a general configuration. That is, an eyeglass frame 200 includes rims which surround the left and right lenses (in this case, the shutters which are formed from liquid crystal cells or the like), a bridge which connects the left and right rims, left and right temples hinge-joined pivotably to the respective side edges on the outer corner sides of the eyes of the left and right rims, and temple tips which are put on the ears at end tips of the respective temples. Also, a hinge portion which supports the temple on the rim is covered by a protective sheath. Also, the left and right rims have nose pads at the inner corner sides of the eyes and are made to pinch the nose from both sides, thereby fixing the eyeglasses. The basic configuration itself of the eyeglass frame 200 is common knowledge.

For example, an infrared light sensing section is incorporated in the bridge portion of the shutter eyeglasses. In this embodiment, a condensing lens is used so as to be able to efficiently receive an infrared signal which is transmitted from the display device, even at a long viewing distance.

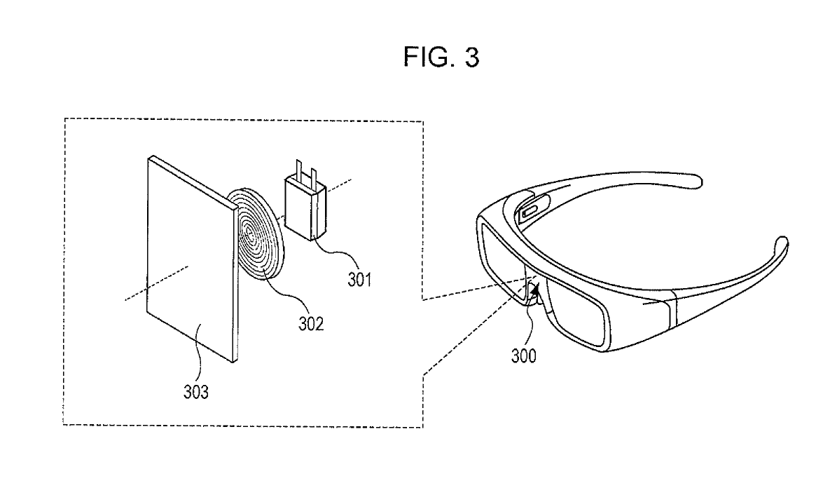

In FIG. 3, a state where a light sensing section is incorporated in the bridge portion of the shutter eyeglasses is illustrated. A light sensing section 300 includes an infrared sensor 301, a condensing lens 302, and an infrared filter 303. The infrared filter 303 transmits only an infrared component of the incident light. The condensing lens 302 concentrates the transmitted light of the infrared filter 303.

In the illustrated example, a Fresnel lens is used for the condensing lens 302. The Fresnel lens is a lens in which a normal lens is divided into concentric areas and the thickness of which is reduced, and has a saw-toothed cross section (common knowledge). In a normal lens, even if the radial position changes, the focal lengths are the same. In contrast, the condensing lens 302 that is used in this embodiment has the property that the larger the radial position becomes, the longer the focal length becomes. Provided that this property is secured, the condensing lens 302 is not limited to the Fresnel lens.

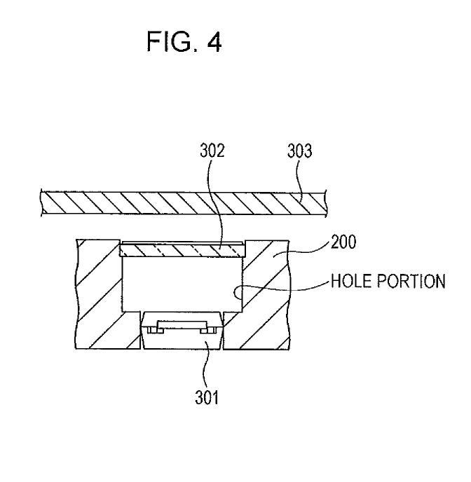

In FIG. 4, a cross-sectional configuration in the vicinity of the light sensing section of the shutter eyeglasses is illustrated. The shutter eyeglasses have a hole portion at the bridge portion and the light receiving sensor 301 is buried in the bottom of the hole portion with a light receiving surface thereof facing outside. Also, the condensing lens 302 is supported at the opening portion of the hole portion and a gap is present between the condensing lens 302 and the light receiving surface of the light receiving sensor 301. Further, the infrared filter 303 is attached outside the condensing lens 302.

Subsequently, an action in which the condensing lens 302 concentrates the incident light is described.

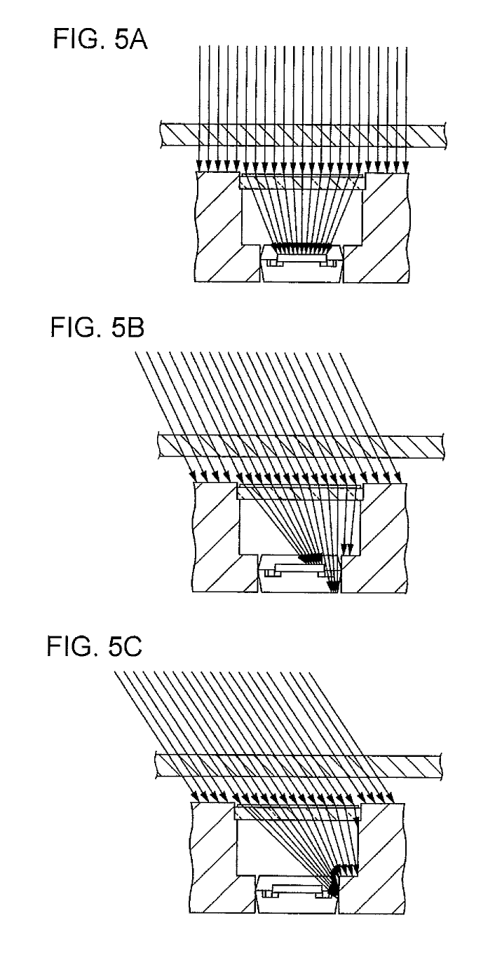

In a case where the focal length of the condensing lens 302 is constant regardless of the radial position, when the incident angle is small, all incident light can be concentrated on the light receiving surface of the light receiving sensor 301 (refer to FIG. 5A) and the light receiving intensity in the light receiving sensor 301 becomes large. However, the proportion of the incident light deviating from the light receiving surface of the light receiving sensor 301 with respect to the incident light on the condensing lens 302 becomes higher as the incident angle becomes larger (refer to FIGS. 5B and 5C), and the light receiving intensity in the light receiving sensor 301 gradually becomes smaller. This means that when the incident angle becomes large at a short viewing distance, light receiving efficiency in the light receiving sensor 301 is lowered.

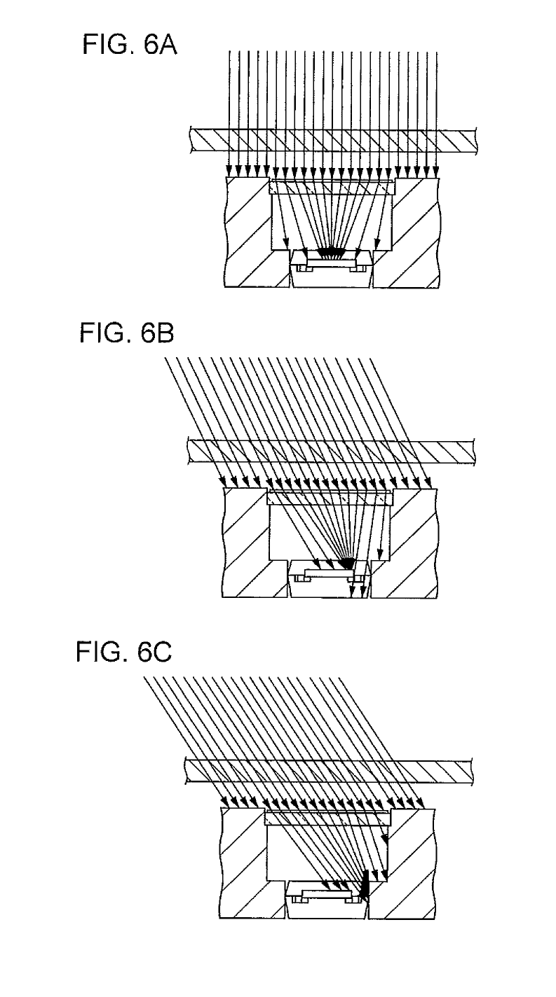

On the other hand, in a case where the focal length of the condensing lens 302 becomes longer as the radial position becomes larger, when the incident angle is small, since the infrared passing through the outside of the condensing lens 302 is not concentrated on the light receiving surface of the light receiving sensor 301 (refer to FIG. 6A), the proportion of the incident light irradiating the light receiving surface of the light receiving sensor 301 with respect to the incident light on the condensing lens 302 is low. That is, if the incident angle is small, since it is not possible to concentrate all incident light on the light receiving surface of the light receiving sensor 301, in comparison with the case of using a normal condensing lens (refer to FIG. 5A), the light receiving intensity in the light receiving sensor 301 is slightly lowered.

In contrast, although the incident light on the condensing lens 302 could be concentrated on the light receiving surface of the light receiving sensor 301 when the incident angle is small, if the incident angle becomes large, the proportion of the incident light deviating from the light receiving surface of the light receiving sensor 301 with respect to the incident light on the condensing lens 302 becomes higher as the incident angle becomes larger. On the other hand, the proportion of the infrared light irradiating the light receiving surface of the light receiving sensor 301 with respect to the infrared light passing through the outside of the condensing lens 302 increases as the incident angle becomes larger. Therefore, even if the incident angle becomes large, the proportion of the incident light capable of being concentrated on the light receiving surface of the light receiving sensor 301 does not fall correspondingly (refer to FIGS. 6B and 6C), and the light receiving intensity in the light receiving sensor 301 is not greatly lowered. This means that even in a case where the incident angle becomes large at a short viewing distance, efficiency of reception in infrared communication is good.

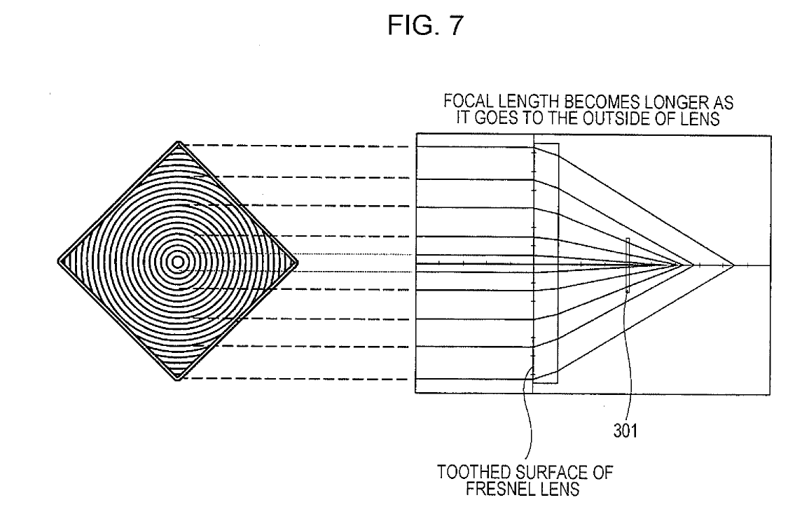

In FIG. 7, a specific configuration example of the condensing lens 302 is illustrated. In the illustrated example, the condensing lens 302 that is made from a Fresnel lens has an outline of a quadrilateral shape in view of restrictions on the mechanism and structure in an implemented product. Provided that the property that a focal length becomes longer as it goes to the outside of a lens is secured, the condensing lens 302 is not limited to a specific outer shape.

Also, in FIG. 7, the focal lengths for the respective radial positions of the lens are shown together. The focal length becomes longer as it goes to the outside of the lens. Also, the light receiving surface of the light receiving sensor 301 is disposed further at the lens side than the shortest focal length.

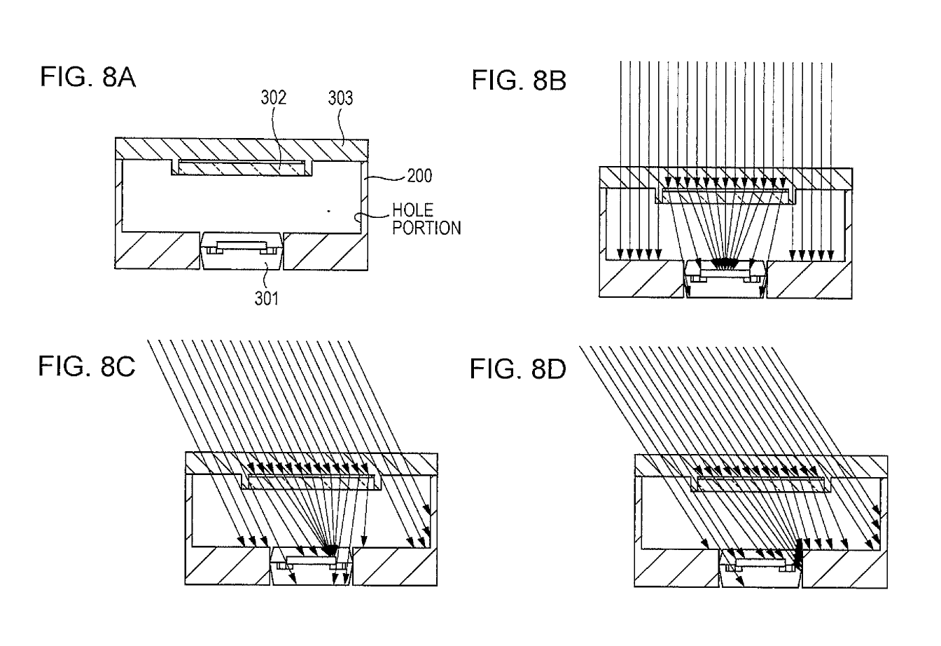

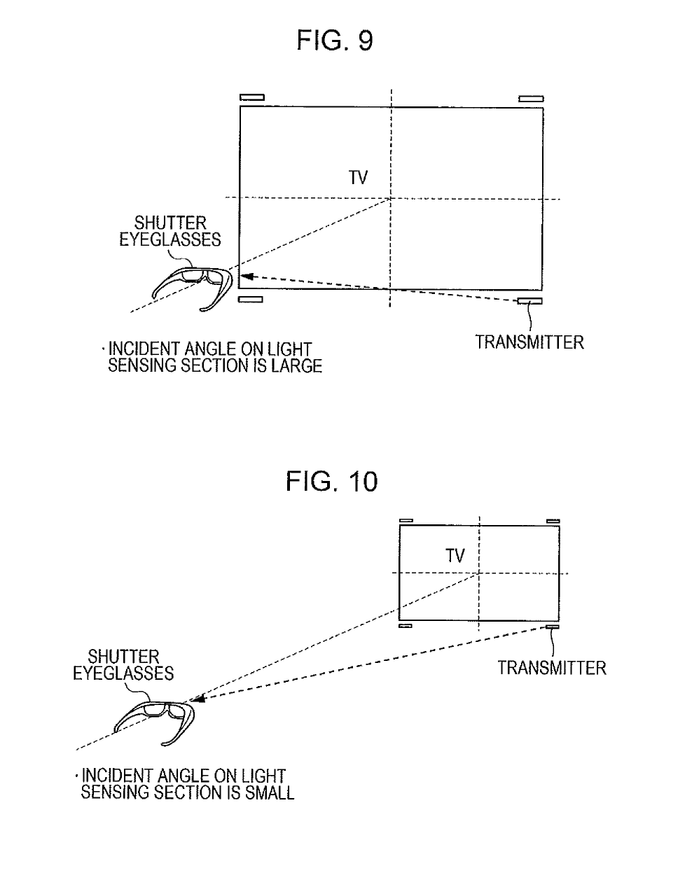

In FIGS. 6A to 6C, an example is illustrated in which the condensing lens 302 is supported at the opening of the hole portion formed in the bridge of the eyeglass frame. However, as a modified example thereof, a method can be provided in which, as shown in FIG. 8A, the size of the opening of the hole portion is made larger than the condensing lens 302 and the condensing lens 302 is supported by the infrared filter 303.

In the case of a configuration in which the condensing lens 302 is supported by the infrared filter 303, as shown in FIG. 8A, the diameter of the opening of the hole portion, in which the light sensing section is buried, can be made large.

When an incident angle is small, since only infrared light concentrated by the condensing lens 302 irradiates the light receiving surface of the light receiving sensor 301 (refer to FIG. 8B), there is little difference in light receiving intensity in the light receiving sensor 301, compared to the case of supporting the condensing lens 302 at the opening portion of the hole portion (refer to FIG. 6A).

In contrast, if the incident angle becomes large, the proportion of the infrared light irradiating the light receiving surface of the light receiving sensor 301 with respect to the infrared light passing through the outside of the condensing lens 302 increases as the incident angle becomes larger. Also, the proportion, in which the infrared that is not incident on the condensing lens 302, but passes through the infrared filter 303 outside the condensing lens 302 irradiates the light receiving surface of the light receiving sensor 301, increases (refer to FIGS. 8C and 8D). Therefore, the light receiving intensity in the light receiving sensor 301 becomes larger than in the case of supporting the condensing lens 302 at the opening portion of the hole portion (refer to FIGS. 6B and 6C), and efficiency of reception in infrared communication is good.

The present disclosure contains subject matter related to that disclosed in Japanese Priority Patent Application JP 2010-129423 filed in the Japan Patent Office on Jun. 4, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. Shutter eyeglasses comprising:
shutter lenses;
an eyeglass frame which supports the shutter lenses;
a light sensing section attached to the eyeglass frame; and
a control section which controls driving of the shutter lenses on the basis of an infrared signal received by the light sensing section,
wherein the light sensing section includes
an infrared light receiving sensor,
an infrared filter, and
a condensing lens which concentrates light that has penetrated the infrared filter, toward the light sensing section and in which the larger the radial position becomes, the longer the focal length becomes.

2. The shutter eyeglasses according to claim 1, wherein the light receiving sensor is buried in a hole portion formed in the eyeglass frame, and
the condensing lens is supported at the opening portion of the hole portion.

3. The shutter eyeglasses according to claim 1, wherein the light receiving sensor is buried in a hole portion formed in the eyeglass frame, and
the condensing lens is supported by the infrared filter attached to the opening portion of the hole portion.
